(19) United States
(12) Patent Application Publication
(10) Pub. No.: US 2014/0225696 A1
(43) Pub. Date: Aug. 14, 2014

(54) MAGNETIC MATERIAL AND METHOD FOR PRODUCING SAME

(71) Applicants: Konrad Güth, Hainburg (DE); Oliver Gutfleisch, Darmstadt (DE)

(72) Inventors: Konrad Güth, Hainburg (DE); Oliver Gutfleisch, Darmstadt (DE)

(73) Assignee: ROBERT BOSCH GmbH, Stuttgart (DE)

(21) Appl. No.: 14/233,847

(22) PCT Filed: Jun. 20, 2012
(86) PCT No.: PCT/EP2012/061778

§ 371 Date: Apr. 28, 2014

(30) Foreign Application Priority Data
Jul. 20, 2011 (DE) 10 2011 108 174.0

(51) Int. Cl. H01F 1/147; H01F 41/02

(52) U.S. Cl. CPC H01F 1/147; H01F 41/0246
USPC 335/302; 75/348; 75/345; 419/30

(57) ABSTRACT

The invention relates to a method for producing a magnetic material, said magnetic material consisting of a starting material that comprises a rare earth metal (SE) and at least one transition metal. The rare earth metal content is 15 to 20 wt. %, and the method has the following steps:—hydrogenating the starting material,—disproportioning the starting material,—desorption, and—recombination. A soft magnetic material is added after the starting material is disproportioned.

### BACKGROUND OF THE INVENTION

The invention relates to a magnetic material and a process for producing it.

Magnetic materials and processes for producing them are known from the prior art. For example, finely crystalline magnetic powders, known as nanocrystalline magnetic powders, are obtained by ball milling or rapid solidification and subsequent hot compaction or hot deforming or else by “exchange coupling or remanence enhancement”. Disadvantages here are the complicated processing of the starting alloy and the often low energy density and remanent magnetization of the magnetic material obtained. Furthermore, DE 197 52 366 A1 describes a process for producing a hard-magnetic samarium-cobalt base material by means of an HDDR process (hydrogenation-disproportionation-desorption-recombination), with the disproportionation being carried out at a hydrogen pressure of greater than 0.5 MPa and a temperature of from 500° C. to 900° C. A disadvantage here is that the magnetic materials obtained in this way have, since they are isotropic, a relatively low remanent magnetization and crystallite sizes of 300 nm and more after desorption and recombination.

### SUMMARY OF THE INVENTION

The process of the invention can be carried out in a simplified way. Here, at least one soft-magnetic phase having a sufficiently small crystallite size is coupled conformally and efficiently to a hard-magnetic phase, with the hard-magnetic phase being textured simultaneously. For the present purposes, texturing or texture formation means that a hard-magnetic phase having a crystallographic preferential direction is formed. The formation of the magnetic material of the invention takes place in a continuous process, with desorption and recombination of the magnetic material taking place either successively or in parallel. This gives a magnetic material which has a high remanent magnetization of preferably from about 1.3 to 1.5 tesla. In addition, the paramagnetic proportion of the material, i.e. the volume of the rare earth metal-rich grain boundary phase, is minimized or ideally eliminated, which increases the remanent magnetization, increases the magnetic properties of the material by efficient exchange coupling and improves its corrosion resistance. The crystallites of the material of the invention are characterized by high texturing, i.e. they have a crystallographic preferential direction. It has surprisingly been found that nucleation, crystal growth and in particular texturing of the magnetic material can be positively influenced by addition of a soft-magnetic material after the disproportionation of the starting material. This increases the remanent magnetization of the material of the invention. The point in time at which the soft-magnetic material is added is after the disproportionation. This means that said material can either be added immediately after disproportionation or else in a later process stage. The point in time at which addition takes place can, for example, be controlled as a function of the initial particle size of the magnetic material. Thus, it has been found that said soft-magnetic material can, for example, also be added after recombination, as long as in this particular case the initial particle size of the magnetic material is less than 5 μm. The final crystallite size of the magnetic material of the invention can be controlled by the process as claimed in claim 1 in such a way that it is at least one size unit smaller than in conventional magnetic materials produced by the HDDR process. Owing to this very small crystallite size of preferably less than 300 nm and particularly preferably less than 100 nm or even less than 50 nm, the exchange coupling of the material of the invention is particularly high, which has a positive effect on the magnetic properties of the material.

In a preferred embodiment of the invention, the soft-magnetic material has a particle size of from 1 to 100 nm, preferably from 5 to 30 nm. The smaller the particle size of the soft-magnetic material, the easier and more comprehensive the exchange coupling of the magnetic material. Preferably, the particle size is therefore at most 100 nm and is particularly preferably in the range from 5 to 30 nm. This promotes a homogeneous, nanosize distribution of the soft- and hard-magnetic phases and a low crystallite size of the magnetic material, which promotes exchange coupling of the magnetic material and provides a magnetic material having a high remanent magnetization.

The soft-magnetic material is not subject to any particular restrictions. However, the soft-magnetic material is preferably composed of Fe and/or Co or of an alloy of these two elements. The elements iron and cobalt and also mixtures thereof or alloys thereof promote texturing of the magnetic material particularly well. An alloy of the elements iron and cobalt which is particularly suitable for the process of the invention is Fe₆₅Co₃₅.

The soft-magnetic material can be added by means of conventional methods such as physical mixing or chemical incorporation, i.e., for example, by vapor deposition or comilling in a vibratory mill at low intensity. The soft-magnetic material is preferably mechanically mixed with the disproportionated material, which makes effective exchange coupling possible. This promotes a homogeneous, nanosize distribution of the soft- and hard-magnetic phases and a low crystallite size of the magnetic material, which in turn promotes exchange coupling of the magnetic material, so that the magnetic material of the invention displays a particularly high remanent magnetization.

The amount of soft-magnetic material is preferably in the range from>0 to 50% by weight, preferably from 10 to 30% by weight, more preferably about 20% by weight, in each case based on the starting material. In this range, the amount of soft-magnetic material is sufficient to allow good exchange coupling combined with a high total magnetization of the magnetic material and thus produce a homogeneous magnetic structure with high texturing therein.

The process of the invention is more preferably characterized in that a magnetic field is applied during at least one process step. Appropriate selection of the magnetic field strength further provides a mechanism by means of which the remanent magnetization of the magnetic material can be set in a targeted manner. Preferably, the magnetic field is applied during the hydrogenation step and the disproportionation step, or else during the desorption step and the recombination step, or else during the hydrogenation step, the disproportionation step and the desorption step. In particular, when the magnetic field is applied during the desorption step and the recombination step, the crystallite size and especially initiation and improvement of the texturing of the magnetic material is particularly strongly influenced by the magnetic field, so that it commences on nucleation and during nucleus growth and texturing of the magnetic material can thus be additionally controlled. This increases the remanent magnetization of the magnetic material.

If the process of the invention is characterized by application of a magnetic field, then the magnetic field strength of the applied magnetic field is more preferably from>0 to about 100 tesla, preferably from>0 to 10 tesla. This field strength is sufficient to bring about a high degree of texturing in the magnetic material and to promote a crystallite size of the desired size and preferably of a few 100 nm and even below 100 nm. The magnetic field strength has no upper limit. In the preferred range of up to 10 tesla, nucleation and the growth rate of the crystallites and in particular the texturing of the material can be controlled optimally at very low production costs. The optimal magnetic field strength can easily be discovered by a person skilled in the art by means of simple comparative experiments.

Furthermore, it is advantageous for the temperature during the hydrogenation step to be from about 20° C. to 350° C., preferably about 300° C., and/or the temperature during the disproportionation step to be from 500° C. to 1000° C., preferably from 750° C. to 850° C., and/or the temperature during the desorption step to be from 500° C. to 1000° C., preferably from 750° C. to 850° C., and/or the temperature during the recombination step to be from 500° C. to 1000° C., preferably from 750° C. to 850° C. The high temperature of at least 500° C. and preferably from 750° C. to a maximum of 1000° C. during the abovementioned reaction steps ensures excellent texturing of the magnetic material, with the reaction rate in the temperature range from 750° C. to 850° C. promoting an optimal course of the reaction in respect of the rate and the process costs. In particular, the high temperature during desorption leads to virtually complete recombination to form the magnetic end product. The temperature which is optimal for the respective magnetic material can easily be discovered by a person skilled in the art by means of simple comparative experiments.

Furthermore, it is advantageous for the hydrogen partial pressure during the hydrogenation step to be from 20 kPa to 100 kPa and more, preferably from 20 kPa to 40 kPa and more preferably 30 kPa, and/or the hydrogen partial pressure during the disproportionation step to be from 20 kPa to 40 kPa, preferably 30 kPa, and/or the hydrogen partial pressure during the desorption step to be from 0.5 kPa to 1.5 kPa, preferably 1 kPa, and/or the hydrogen partial pressure during the recombination step to be from 0 kPa to 1 kPa, preferably 0 kPa. The high pressures of up to 100 kPa and more during the hydrogenation step are particularly advantageous for high-alloy starting materials, while pressures of from 20 to about 40 kPa are sufficient for low-alloy starting materials. The pressures during the disproportionation step and also during the recombination step can vary as a function of the soft-magnetic material used. Thus, when using cobalt as soft-magnetic material or when using high cobalt-alloyed iron-cobalt alloys, they may preferably be higher than when using pure iron. These process conditions promote texturing of the magnetic material. They also simplify carrying out the reaction and are therefore advantageous. The optimal pressure for the respective magnetic material can easily be discovered by a person skilled in the art by means of simple comparative experiments.

During the disproportionation step, it is advantageous for the hydrogen partial pressure in the case of low-alloy starting materials to be in the range from 20 kPa to 40 kPa in order to ensure a sufficient amount of hydrogen for absorption by the starting material. A hydrogen partial pressure of 30 kPa is particularly preferred from a process engineering point of view and also from an economic point of view.

The hydrogen partial pressure during the desorption step is preferably in the range from 0.5 to 1.5 kPa in order to accelerate desorption of the hydrogen, which takes place particularly simply and completely at a hydrogen partial pressure of 1 kPa.

It is particularly advantageous for the starting material to be milled during and optionally before the hydrogenation step and/or the disproportionation step by milling, in particular ball milling and especially by reactive ball milling. If the ball milling is carried out in the hydrogenation step, it is preferably effected by reactive ball milling. The ball milling or reactive ball milling promotes the formation of very small crystallites, which has a positive effect on the crystallite size and the texturing of the magnetic material of the invention. A further advantage of the ball milling is that the particle size of the starting material can then be greater, since this is reduced sufficiently by the step of ball milling. The ball milling preferably reduces the crystallite size of the starting material and/or of the material formed during the hydrogenation step and/or the disproportionation step to less than 50 nm and more preferably to from 5 to 20 nm. If the ball milling is carried out before the hydrogenation step, this can also be carried out at a temperature of about 20° C., which significantly reduces process costs.

As an alternative, ball milling can also be carried out under a hydrogen atmosphere, which leads to a shortened milling time and thus also to reduced process costs. Furthermore, the hydrogenation then takes place within a very short time because of the now small crystallite sizes of the magnetic material, with virtually complete reaction of the starting material being achieved. A further advantage of the ball milling is that the temperature which has to be employed during the recombination step can be reduced thereby, namely by about 200° C., which gives a preferred temperature range during the recombination step of a ball-milled magnetic material of from about 640° C. to 750° C. Such a low temperature range leads, in contrast to the conventional HDDR process, to only partial recombination of the magnetic material. Furthermore, this relatively low temperature during the recombination step promotes a particularly small crystallite size of the magnetic material. Ball milling can be carried out by means of conventional apparatuses.

The H₂ pressure applied during milling is preferably at least 0.1 MPa, preferably at least 1 MPa, more preferably at least 10 MPa, as a result of which the starting material and/or the material formed during the hydrogenation step and/or disproportionation step attains a crystallite size of less than 50 nm and preferably from 5 to 20 nm. The H₂ pressure indicated ensures rapid and sufficiently good, homogeneous milling and thus disproportionation. The magnitude of the H₂ pressure to be employed can easily be discovered by a person skilled in the art by means of appropriate preliminary experiments.

The magnetic material is preferably hot-deformed and/or hot-compacted during the desorption step and/or the recombination step. The texturing of the magnetic material can likewise be influenced by the hot-compacting and/or hot-deformation, which can also be an upsetting operation.

The temperature during deforming is for this purpose more advantageously from 400 to 1200° C., preferably from 600 to 900° C., and the pressure during forming is advantageously at least 100 MPa, preferably at least 150 MPa. Very good texturing can be achieved in these temperature and pressure ranges. The optimal temperature and the optimal pressure can easily be discovered by a person skilled in the art by means of simple comparative experiments.

In a preferred embodiment, the process is carried out in such a way that the intermediate produced after the disproportionation step and/or after milling is a stoichiometric intermediate. This means that the intermediate is present as a single phase, i.e. there are no intergranular rare earth-metal rich phases present. The primary hydrogenated intermediate is thus REH₂, where RE represents rare earth metal(s). This can be brought about by targeted selection of the parameters temperature, hydrogen partial pressure, reaction time and magnetic field strength. Thus, for example, in the case of an Nd₂Fe₁₄B phase, the stoichiometric (nominal) composition:

Nd_{26.67}Fe_{72.33}B_{1.0} (% by weight)

Nd_{11.77}Fe_{82.35}B_{5.88} (atom %)

is meant.

A superstoichiometric NdH₂₊ₓ is often initially formed, and this is subsequently transformed into the stable NdH₂ (stoichiometric composition of this phase). In the case of hydrogen milling (ball milling under a hydrogen atmosphere), the Nd₂F₁₄B, for example, is transformed into the three abovementioned disproportionated stages, with NdH₂₊ₓ also being formed. If this powder is then heated, e.g. to 650° C., this superstoichiometric phase is converted at about 200-300° C. into a stable NdH₂ phase and hydrogen is liberated.

In an alternative preferred embodiment, the process is carried out so that the intermediate produced after the disproportionation step and/or after milling is a superstoichiometric intermediate. This means that REH₃, i.e. generally also REH₂₊ₓ, is present in addition to REH₂. This can be brought about by targeted selection of the parameters temperature, hydrogen partial pressure and reaction time.

The rare earth metal is preferably selected from the group consisting of: Nd, Sm, La, Dy, Tb, Gd, particularly preferably from among: Nd, Sm, La. Owing to their physical and chemical properties, these rare earth metals can be reacted particularly well by means of the process of the invention.

Furthermore, the transition metal is preferably selected from the group consisting of: Fe and Co. These two transition metals are readily available and comparatively advantageous and display very good magnetic properties.

The magnetic material, and preferably the starting material, more preferably contain(s) at least one further element such as, in particular, B and/or Ga and/or Nb and/or Si and/or Al. These elements can influence the magnetic and also physical and chemical properties of the material and its stability, i.e. its chemical or electrochemical stability (e.g. corrosion resistance). Boron is particularly preferred since it promotes the structure formation of the magnetic material, i.e. in particular, the hard-magnetic phase of the Nd2Fe14B type.

Furthermore, the invention describes a permanent magnet which comprises at least one rare earth metal and at least one transition metal and has been produced by the above-described process. This permanent magnet displays a particularly high saturation magnetization and a high remanent magnetization, and also high texturing.

Preferred compositions of the permanent magnet are NdTM₁₂ and Sm₂TM₁₇, where TM is a transition metal. Particularly preferred compositions are Sm₂Fe₁₇, SmCo₅, and, owing to its excellent magnetic properties, very particularly preferably Nd₂Fe₁₄B.

The permanent magnet of the invention preferably has a remanent magnetization of from 1.3 to 1.5 tesla.

In summary, the invention provides a process for producing a magnetic material from a starting material, wherein the starting material comprises at least one rare earth metal (RE) and at least one transition metal and the process comprises the steps known from the conventional HDDR process: hydrogenation of the starting material, disproportionation of the starting material, desorption and recombination, with, after the disproportionation of the starting material, a soft-magnetic material being added.

### BRIEF DESCRIPTION OF THE DRAWINGS

The invention will be described in detail below with reference to the drawings 1 to 6. In the drawing:

FIG. 1 shows a schematic overview of the conventional HDDR process,

FIG. 2 shows a schematic overview of a first example according to the invention,

FIG. 3 shows a schematic overview of a second example according to the invention,

FIG. 4 shows a schematic overview of a third example according to the invention,

FIG. 5a is a diagram which shows the dependence of the crystallite size and the coercive field strength (μ₀H_{c}) of a superstoichiometric magnetic material milled by means of a ball mill on the temperature during the recombination step.

FIG. 5b is a diagram which shows the dependence of the crystallite size and the coercive field strength (μ₀H_{c}) of a stoichiometric magnetic material milled by means of a ball mill on the temperature during the recombination step.

FIG. 6a shows a high-resolution scanning electron micrograph (LEO FEG 1530 Gemini) of an Nd_{28.78}Fe_{ba1}B_{1.1}Ga_{0.35}Nb_{0.26} material which was produced by means of a conventional HDDR process.

FIG. 6b shows a high-resolution scanning electron micrograph (LEO FEG 1530 Gemini) of an Nd_{28.78}Fe_{ba1}B_{1.1}Ga_{0.35}Nb_{0.26} material which was produced by means of an HDDR process and additional milling by means of a ball mill.

### DETAILED DESCRIPTION

The conventional HDDR process is described below with reference to FIG. 1.

As can be seen from FIG. 1, the HDDR process 10 comprises the reaction steps: hydrogenation 1, disproportionation 2, desorption 3 and recombination 4. In the hydrogenation step 1, hydrogen is, for example, supplied to an Nd₂Fe₁₄B block having an initial particle size of, for example, from about 50 to 100 μm at a temperature rising to 840° C. The hydrogen partial pressure is increased to 30 kPa in the system, resulting in disproportionation of the starting material with absorption of hydrogen and thus in formation of NdH₂, Fe and Fe₂B. The hydrogen partial pressure is maintained until an equilibrium in which a plurality of phases, i.e. not only NdH₂ but also NdH₂₊ₓ, for example NdH₃, are present (superstoichiometric intermediate) has been established. The composition of the reaction mixture is determined by means of conventional methods (e.g. X-ray diffraction). In the subsequent desorption and recombination steps 3 and 4, the temperature continues to be maintained at 840° C. but the hydrogen partial pressure is reduced to 1 kPa through to a final 0.1 kPa. Here, recombination of the individual phases to form Nd₂Fe₁₄B takes place with liberation of hydrogen. The crystallite size of the magnetic material formed is typically from 200 to 400 nm in this case. The texturing of the material obtained is low, with a remanent magnetization of typically about 0.8 tesla being achieved.

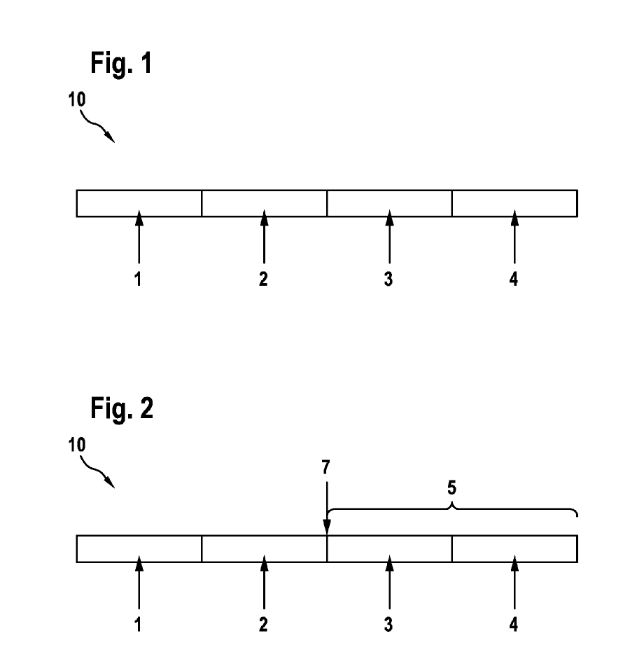

FIGS. 2 to 4 show an overview of three examples of the present invention. In all these examples, the abovementioned reaction steps: hydrogenation 1, disproportionation 2, desorption 3 and recombination 4 are carried out in this order.

FIG. 2 shows a first example. Here, an Nd₂Fe₁₄B block having an initial particle size of from 50 to 300 μm is hydrogenated and disproportionated. The starting alloy material is stoichiometric. No intergranular rare earth metal-rich phases are present. The composition of the reaction mixture is determined by means of conventional methods (e.g.: X-ray diffraction). The temperature of the system is 300° C. during the hydrogenation step 1 and 800° C. during the disproportionation step 2 and the desorption step 3, with the hydrogen partial pressure being maintained at 30 kPa up to the desorption step 3 and being reduced to 1 kPa during the desorption step 3 and then further to 0 kPa. In addition, a magnetic field 5 of 8 tesla is applied to the system during the desorption step 3 and the recombination step 4. After the disproportionation step 2, from>0% by weight to 50% by weight, preferably 25% by weight, of nanoparticulate iron 7, based on the starting compound, is additionally added. The particle size of the iron is typically from 5 to 50 nm. The crystallite size of the magnetic end product is typically less than 50 nm. The crystals are characterized by means of X-ray diffraction. The texturing of the magnetic material obtained is high. The remanent magnetization is typically about 1.3 tesla.

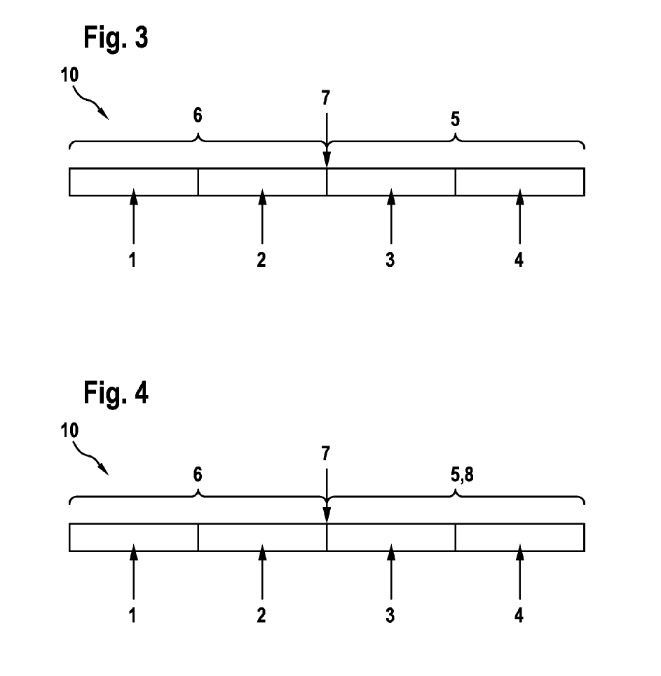

FIG. 3 shows a second example. Here, an Nd₂Fe₁₄B block having an initial particle size of from 50 to 150 μm is hydrogenated and disproportionated. The starting alloy material is stoichiometric. No intergranular rare earth metal-rich phases are present. The composition of the reaction mixture is determined by means of conventional methods (e.g.: X-ray diffraction). In addition, the starting compound is milled by means of ball milling 6 in steps 1 and 2 so that the resulting primary crystallite size is from 2 to 5 μm. The temperature of the system is 300° C. during the hydrogenation step 1 and 800° C. during the disproportionation step 2 and the desorption step 3, with the hydrogen partial pressure being maintained at 30 kPa up to the desorption step 3 and being reduced to 1 kPa during the desorption step 3 and then further to 0 kPa. In addition, a magnetic field 5 of 8.0 tesla is applied to the system during the desorption step 3 and the recombination step 4. After the disproportionation step 2, from>0% by weight to 50% by weight, preferably 30% by weight, of nanoparticulate iron 7, based on the starting compound, is additionally added. The particle size of the iron is typically from 5 to 50 nm. The crystallite size of the magnetic end product is typically less than 50 nm. The crystals are characterized by means of X-ray diffraction. The texturing of the magnetic material obtained is high. The remanent magnetization is typically about 1.4 tesla.

FIG. 4 shows a third example. Here, an Nd₂Fe₁₄B block having an initial particle size of from 120 to 200 μm is hydrogenated and disproportionated. The starting alloy material is stoichiometric. No intergranular rare earth metal-rich phases are present. The composition of the reaction mixture is determined by means of conventional methods (e.g.: X-ray diffraction). In addition, the starting compound is milled by means of ball milling 6 in steps 1 and 2 so that the resulting crystallite size is from 2 to 5 μm. The temperature of the system is 250° C. during the hydrogenation step 1 and 800° C. during the disproportionation step 2 and the desorption step 3, with the hydrogen partial pressure being maintained at 30 kPa up to the desorption step 3 and being reduced to 1 kPa during the desorption step 3 and then further to 0 kPa. After the disproportionation step 2, from>0% by weight to 50% by weight, preferably 25% by weight, of nanoparticulate iron 7, based on the starting compound, is additionally added. The particle size of the iron is typically from 5 to 50 nm. In addition, a magnetic field 5 of 8.0 tesla is applied to the system during the desorption step 3 and the recombination step 4 and the reaction mixture is hot-deformed by means of a press in a hot deformation 8 at a temperature of 850° C. and a pressure of 150 MPa during steps 3 and 4. The crystallite size of the magnetic end product is typically less than 50 nm. The crystals are characterized by means of X-ray diffraction. The texturing of the magnetic material obtained is high. The remanent magnetization is typically 1.4 tesla.

Furthermore, comparative experiments on the production of a magnetic material were carried out. The following starting materials were used:

a) Nd_{28.78}Fe_{ba1}B_{1.1}Ga_{0.35}Nb_{0.26} (superstoichiometric, rich in Nd)

b) Nd_{27.07}Fe_{ba1}B_{1.0}Ga_{0.32}Nb_{0.28} (near stoichiometric, negligible Nd excess).

The starting materials were homogenized for about 40 hours under an argon atmosphere in a furnace at a temperature of 1140° C., i.e. the Nd₂Fe₁₄B phase was formed in the material by the heat treatment. The material obtained was then coarsely milled and sieved in order to obtain a particle size of about 250 μm. The coarse powders were subsequently mechanically milled by means of ball milling in a milling cup for 5 hours under a hydrogen partial pressure of 10 MPa. The material hydrogenated and disproportionated during this treatment. After the disproportionation, 10% by weight of iron based on the starting material, having an average particle size of about 20 nm, are added to the reaction mixture and milled homogeneously therewith. The desorption and recombination step was then carried out in a temperature range from 600° C. to 840° C. over a period of about 15 minutes.

The composition of the individual phases of the magnetic material and the crystallite size of this were determined by means of X-ray diffraction (Rietveld refinement, as described in “J. I. Langford, Proc. Int. Conf: Accuracy in powder diffraction II; Washington, D.C.: NIST Special Publication No. 846, US Government Printing Office, 110 (1992)”). The morphology of the magnetic powder material obtained was determined by means of high-resolution scanning electron microscopy (LEO FEG 1530 Gemini). The powders obtained were pressed to a cylindrical shape (diameter: 3.73 mm; height: about 2.1 mm) in a transverse magnetic field of 2 tesla and fixed by means of a commercial epoxy resin. The magnetic measurements were carried out in a vibrating sample magnetometer (VSM) in a magnetic field of up to 9 tesla at room temperature. The X-ray density was 7.5 g/cm³ and the demagnetization factor N was 1/3.

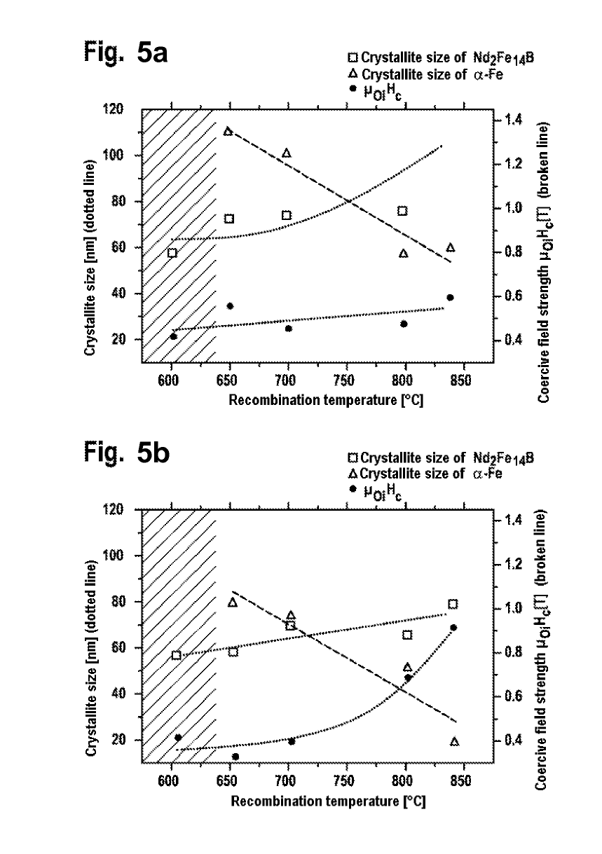

FIG. 5a shows the dependence of the crystallite size and the coercive field strength H_{c} (μ₀H_{c}) of the superstoichiometric magnetic material on the temperature during the recombination step. The hatched region in FIG. 5a shows the temperature range in which recombination is incomplete. FIG. 5a thus illustrates that recombination is incomplete at temperature of less than 650° C., while recombination at temperatures of 840° C. or above leads to a significantly larger crystallite size of the Nd₂Fe₁₄B product of about 115 nm, which is presumably attributable to melting of the Nd-rich phase at temperatures above 670° C. This leads to increased diffusion and thus increased crystallite growth. An increase in the temperature to above 700° C. during the recombination step leads in this case to no appreciable increase in the crystallite size of the α-Fe. The crystallite size of the α-Fe was largely about 30 nm.

As indicated above, the same experiments as were carried out for the superstoichiometric material were also carried out for the abovementioned stoichiometric material (material b)). After milling, the stoichiometric product likewise consisted of α-Fe and NdH₂ (Fe₂B was not detected for the same reasons as indicated above). After recombination to form Nd₂Fe₁₄B, α-Fe (about 6-7% by weight) and NdO (from 0.6 to 0.8% by weight) were likewise detected as by-products. FIG. 5b shows the dependence of the crystallite size of the magnetic material on the temperature and the coercive field strength H_{c} (μ₀H_{c}) during the recombination step of the stoichiometric material mentioned above under b) (Nd_{27.07}Fe_{ba1}B_{1.0}Ga_{0.32}Nb_{0.28}). The hatched region in FIG. 5b once again shows the temperature range in which recombination is incomplete. The crystallite size at temperatures of up to about 700° C. was virtually identical to that obtained for the superstoichiometric product in the same temperature range. However, an increase in the temperature during the recombination step to above 700° C. here led to an increase in the crystallite size of the α-Fe to about 70 nm. However, at a temperature of 840° C., the crystallite size of the Nd₂Fe₁₄B obtained from the stoichiometric material b) is 80 nm and thus lower than in the superstoichiometric case (115 nm, see above). This is presumably attributable to the absence of Nd-rich phases in the stoichiometric material.

The abovementioned measurements were carried out for the magnetic materials obtained in each case from the stoichiometric and superstoichiometric starting material. The materials displayed a magnetic behavior which indicated a single magnetic phase. The materials which had been derived from the superstoichiometric starting alloy and been recombined at about 650° C. showed a coercive field strength of 1.35 tesla, while the materials which had been derived from the superstoichiometric starting alloy and been recombined at about 840° C. showed a coercive field strength of only 0.9 tesla, which is presumably attributable to the large increase in the crystallite size of the α-Fe. The remanent magnetization was 0.85 tesla, regardless of the temperature during the recombination step, and can optionally be increased by addition of iron. The recombined material from the stoichiometric starting alloy displayed a coercive field strength of 1.05 tesla.

In a further comparative experiment, magnetic materials were produced by the conventional HDDR process as shown in FIG. 1. For this purpose, the abovementioned superstoichiometric material, Nd_{28.78}Fe_{ba1}B_{1.1}Ga_{0.35}Nb_{0.26}, and the abovementioned stoichiometric material, Nd_{27.07}Fe_{ba1}B_{1.0}Ga_{0.32}Nb_{0.28}, were again used as starting material. After disproportionation the composition of the materials was as follows: 70% by weight of α-Fe, 25.4% by weight of NdH₂ and 4.6% by weight of Fe₂B. However, the crystallite size of the individual phases was 30 nm, 15 nm and 20 nm, respectively, and was thus distinctly greater than that obtained in processes mentioned above by additional ball milling. The microdeformation of α-Fe was 0.20%, that of NdH₂ was 0.77% and that of Fe₂B was 0.08% and was thus significantly lower than in processes mentioned above. Complete recombination was obtained only at a temperature of at least 840° C. (about 99.5% by weight recombination to form Nd₂Fe₁₄B), with the balance being NdO (about 0.5% by weight). The average crystallite size of the magnetic material was in each case about 300 nm and was thus more than an order of magnitude greater than that obtained by processes mentioned above. The remanent magnetization of the superstoichiometric material was 1.25 tesla. The coercive field strength of the superstoichiometric material was 1.55 tesla. The remanent magnetization of the stoichiometric material was 0.94 tesla and was thus significantly lower than in the superstoichiometric case. The coercive field strength of the stoichiometric material was, owing to the lack of Nd-rich phases, about 0.22 tesla.

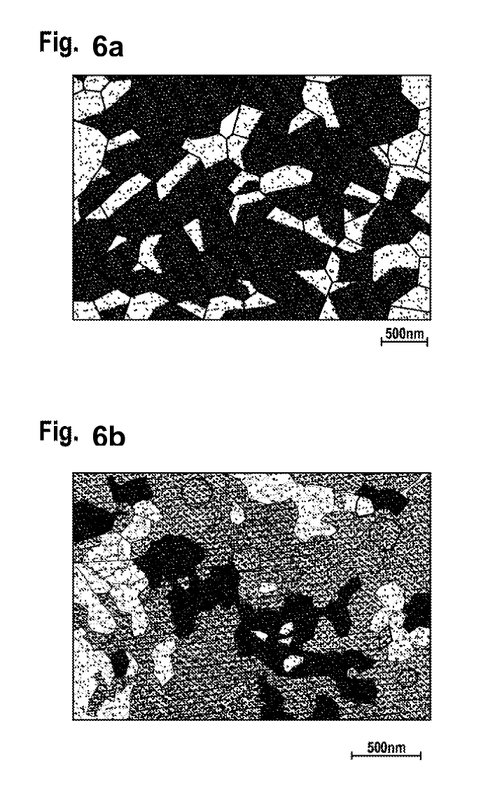

FIGS. 6a and 6b show high-resolution scanning electron micrographs (LEO FEG 1530 Gemini) by means of which the morphology of a superstoichiometric Nd_{28.78}Fe_{ba1}B_{1.1}Ga_{0.35}Nb_{0.26} material which had been produced by means of a conventional HDDR process (FIG. 6a) compared to a superstoichiometric Nd_{28.78}Fe_{ba1}B_{1.1}Ga_{0.35}Nb_{0.26} material which had been produced by means of the HDDR process according to the invention and additional milling by means of a ball mill (FIG. 6b) with addition of 10% by weight of iron having an average particle size of about 20 nm after the disproportionation step, as described above, was determined. The micrographs of the two materials were taken before the respective desorption and recombination step at 800° C. It can very clearly be seen that the crystallite size of the additionally ball-milled material (FIG. 6b) is significantly lower than that of a material produced by the conventional HDDR process.

As shown, a textured magnetic material having a very high remanent magnetization of preferably from 1.3 to 1.5 tesla can be obtained by means of the process of the invention. Correspondingly, improved permanent magnets can be produced from this magnetic material. The magnetic material of the invention can be produced particularly inexpensively. Adding a soft-magnetic material after the disproportionation of the starting material can positively influence the texturing and also nucleation and the growth process of the magnetic material in respect of the remanent magnetization. This is preferably further promoted by setting of the hydrogen partial pressure.

1. A process for producing a magnetic material from a starting material, where the starting material comprises at least one rare earth metal (RE) and at least one transition metal, which comprises the steps:
hydrogenation of the starting material,
disproportionation of the starting material,
desorption and
recombination,
wherein a soft-magnetic material is added after the disproportionation of the starting material.

2. The process as claimed in claim 1, characterized in that the soft-magnetic material has a particle size of from 1 to 100 nm.

3. The process as claimed in claim 1, characterized in that the soft-magnetic material is Fe and/or Co or an alloy of the two elements.

4. The process as claimed in claim 1, characterized in that the addition of the soft-magnetic material is carried out by mechanical mixing.

5. The process as claimed in claim 1, characterized in that the amount of soft-magnetic material is from>0% by weight to 50% by weight, based on the starting material.

6. The process as claimed in claim 1, characterized in that a magnetic field is applied during at least one step.

7. The process as claimed in claim 6, characterized in that the magnetic field strength of the applied magnetic field is from>0 to 100 tesla.

8. The process as claimed in claim 1, characterized in that the temperature during the hydrogenation step is from about 20° C. to 350° C., and/or the temperature during the disproportionation step is from 500° C. to 1000° C., and/or the temperature during the desorption step is from 500° C. to 1000° C., and/or the temperature during the recombination step is from 500° C. to 1000° C.

9. The process as claimed in claim 1, characterized in that the hydrogen partial pressure during the hydrogenation step is from 20 kPa to 100 kPa and more, and/or the hydrogen partial pressure during the disproportionation step is from 20 kPa to 40 kPa, and/or the hydrogen partial pressure during the desorption step is from 0.5 kPa to 1.5 kPa, and/or the hydrogen partial pressure during the recombination step is from 0 kPa to 1 kPa.

10. The process as claimed in claim 1, characterized in that the starting material is milled, during and/or before the hydrogenation step and/or the disproportionation step.

11. The process as claimed in claim 10, characterized in that the hydrogen pressure applied during milling is at least 0.1 MPa, as a result of which the starting material and/or the material formed during the hydrogenation step and/or disproportionation step attains a crystallite size of less than 50 nm.

12. The process as claimed in claim 1, characterized in that the magnetic material is hot-deformed and/or hot-compacted during the desorption step and/or the recombination step.

13. The process as claimed in claim 12, characterized in that the temperature during hot deformation and/or hot compacting is from 400 to 1200° C., and the pressure is at least 100 kPa.

14. The process as claimed in claim 1, characterized in that
the rare earth metal (RE) is selected from the group consisting of: Nd, Sm, La, Dy, Tb, Gb, and/or
the transition metal is selected from the group consisting of: Fe and Co.

15. The process as claimed in claim 1, characterized in that the magnetic material contains at least one further element.

16. A permanent magnet produced by a process as claimed in claim 1, wherein the magnetic material forming the permanent magnet is Nd₂Fe₁₄B.

17. The process as claimed in claim 1, characterized in that the soft-magnetic material has a particle size of from 5 to 30 nm.

18. The process as claimed in claim 1, characterized in that the soft-magnetic material is Fe₆₅Co₃₅.

19. The process as claimed in claim 1, characterized in that the amount of soft-magnetic material is from 10% by weight to 30% by weight, based on the starting material.

20. The process as claimed in claim 6, characterized in that the magnetic field strength of the applied magnetic field is>0 to 10 tesla.

21. The process as claimed in claim 1, characterized in that the temperature during the hydrogenation step is about 300° C., and/or the temperature during the disproportionation step is from 750° C. to 850° C., and/or the temperature during the desorption step is from 750° C. to 850° C., and/or the temperature during the recombination step is from 750° C. to 850° C.

22. The process as claimed in claim 1, characterized in that the hydrogen partial pressure during the hydrogenation step is from 20 kPa to 40 kPa, and/or the hydrogen partial pressure during the disproportionation step is 30 kPa, and/or the hydrogen partial pressure during the desorption step is 1 kPa, and/or the hydrogen partial pressure during the recombination step is 0 kPa.

23. The process as claimed in claim 1, characterized in that the starting material is milled by ball milling during and/or before the hydrogenation step and/or the disproportionation step.

24. The process as claimed in claim 23, characterized in that the hydrogen pressure applied during milling is at least 1 MPa, as a result of which the starting material and/or the material formed during the hydrogenation step and/or disproportionation step attains a crystallite size of from 5 to 20 nm.

25. The process as claimed in claim 12, characterized in that the temperature during hot deformation and/or hot compacting is from 600 to 900° C., and the pressure is at least 150 kPa.

26. The process as claimed in claim 1, characterized in that
the rare earth metal (RE) is selected from the group consisting of: Nd, Sm, La, and/or
the transition metal is selected from the group consisting of: Fe and Co.

27. The process as claimed in claim 1, characterized in that the hydrogen partial pressure during the hydrogenation step is 30 kPa, and/or the hydrogen partial pressure during the disproportionation step is 30 kPa, and/or the hydrogen partial pressure during the desorption step is 1 kPa, and/or the hydrogen partial pressure during the recombination step is 0 kPa.

28. The process as claimed in claim 23, characterized in that the hydrogen pressure applied during milling is at least 10 MPa, as a result of which the starting material and/or the material formed during the hydrogenation step and/or disproportionation step attains a crystallite size of from 5 to 20 nm.
